(19) United States
(12) Patent Application Publication
(10) Pub. No.: US 2007/0271165 A1
(43) Pub. Date: Nov. 22, 2007

(54) Debt redemption fund

(75) Inventor: Eric-Vincent Guichard, Washington, DC (US)

Correspondence Address: MCKENNA LONG & ALDRIDGE LLP, 1900 K STREET, NW, WASHINGTON, DC, 20006, US

(73) Assignee: GRAVITAS, Washington, DC (US)

(21) Appl. No.: 11/714,280

(22) Filed: Mar. 6, 2007

Related U.S. Application Data
(60) Provisional application No. 60/779,395, filed on Mar. 6, 2006.

(51) Int. Cl. G06Q 40/00

(52) U.S. Cl. 705/36 R

(57) ABSTRACT

The intent of the debt redemption fund discussed herein is to structure a process by which the sovereign or institutional investor can access liquidity on preferential terms, provision for future obligations while meeting current domestic or existing short term obligations, and garner a credit rating that would facilitate future direct access to capital markets on an unfettered basis.

This application claims the benefit of U.S. Provisional Patent Application No. 60/779,395, filed on Mar. 6, 2006, which is hereby incorporated by reference for all purposes as if fully set forth herein.

### BACKGROUND OF THE INVENTION

1. Field of the Invention

The present invention relates to a debt redemption fund (the DRF), which is an asset liability management (ALM) tool targeted at sovereign and institutional investors interested in hedging long-term outstanding foreign exchange obligations.

2. Discussion of the Related Art

For a sovereign or institution with substantial debt, external liability payments are made by national budgets, which at times requires the setting aside of other national priorities. Often, most of these external liabilities require Sinking Fund set-aside provisions when the loan is originally contracted. A sinking fund is a fund to which organization contributes money over time in order to retire or reduce its debt.

Sinking Fund principal is expected to contribute to repayment of loan principal at maturity. However, despite the Sinking Funds, in many cases much of the repayment burden at maturity of the liability remains with national budget.

In many cases, sovereigns with substantial debt obligations have no active Asset/Liability Management Framework, nor do they have dedicated external sources of revenues. In other cases, the sovereigns have no Debt Repayment Provisions.

The debt repayment structure using sinking funds is illustrated in FIG. 1.

In FIG. 1, a government has mandated set-asides from its National Budget to fund external and domestic liabilities, for example 2.5%-6.5% of outstanding principal liabilities funded annually. In the example illustrated in FIG. 1, the National Budget is funded primarily by foreign exchange from economic activity.

The sinking fund may have an external manager, as shown in FIG. 1, but principal is at risk and parameters are conservative. Thus, the returns are low and contribution to debt repayment is minimal at best. Whatever the contribution to debt repayment is, it is still a non-reimbursed, “out-of-pocket”, from the National Budget.

What is needed is a financial structure in which both Assets and Liabilities are managed effectively—thereby reducing external liability burdens on National Budget.

What is needed is for Debt Sinking Funds (or Debt Repayment Set-Asides) to be more substantive contributors to debt repayment, which can be done safely and still substantively support National Budgets in their external debt repayment. Furthermore, there needs to be an financial vehicle where returns generated reimburse the National Budget for external debt payments. Such a vehicle should in certain circumstances, pay off the Principal and Interest of the liability at term, rather than having the principal and interest be paid out of the national budget. Furthermore, the vehicle should provide for the principal invested to be fully protected at term, by the full faith and credit of well known and trusted third parties.

### SUMMARY OF THE INVENTION

Accordingly, the present invention is directed to a debt redemption fund that substantially obviates one or more of the problems due to limitations and disadvantages of the related art.

An advantage of the present invention is to provide a process by which the sovereign or institutional investor can access liquidity on preferential terms, provision for future obligations while meeting current domestic or existing short term obligations, and garner a credit rating that would facilitate future direct access to capital markets on an unfettered basis.

Another advantage of the present invention is to provide a fund which allows sovereign or institutional investors to access liquidity on preferential terms, provision for future obligations while meeting current domestic or existing short term obligations, and garner a credit rating that would facilitate future direct access to capital markets on an unfettered basis

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, describes a method for reducing the unfunded liability of an institution including identifying a range of investment vehicles; calculating a plurality of specific risk profiles for said investment vehicles; developing a composite volatility measure to allow the application of additional capital up to several multiples of the original amount invested to leverage or enhance the returns of the underlying investment; and wrapping a principal protection guaranty to mitigate risk of loss of the original investment.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a diagram representing relationships between the national budget and the creditor.

FIG. 2 is a diagram illustrating the relationships between the national budget, the debt redemption fund and the creditors according to one embodiment of the present invention.

FIGS. 3-7 illustrate transactions according to exemplary embodiments of the present invention.

FIG. 8 illustrates a portfolio allocation according to an exemplary embodiment of the present invention.

FIGS. 9-12 illustrate portfolio profiles according to exemplary embodiments of the present invention.

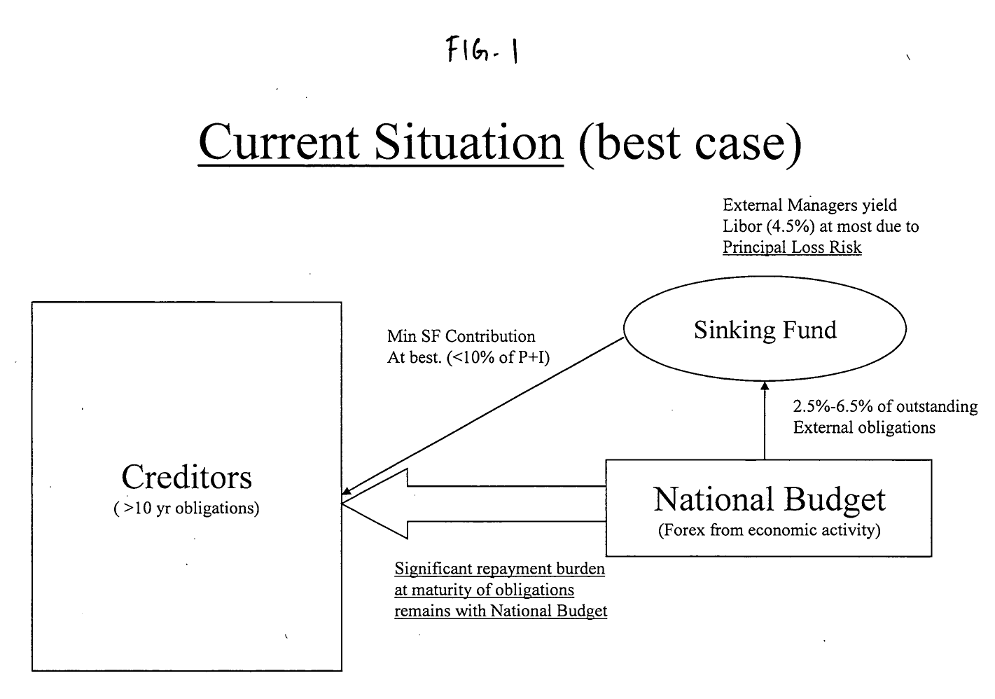

### DETAILED DESCRIPTION OF THE ILLUSTRATED EMBODIMENTS

Reference will now be made in detail to an embodiment of the present invention, example of which is illustrated in the accompanying drawings.

The present invention describes exemplary business methods to develop a debt repayment provisioning tool to eliminate future unfunded liabilities or obligations, generate enhanced and sustainable income, effect comprehensive asset liability management and improve capital market access by strengthening credit standing or ratings. Modeling and allocating risk, applying leveraged capital to enhance underlying investment returns, and then providing principal protection to mitigate downside losses produces a means to generate returns sufficient to produce the desired result.

The business method requires several steps to produce the elimination or reduction of the unfunded liability or debt. The steps include identifying a range of investment vehicles and calculating their specific risk profiles and developing a composite volatility measure to allow the application of additional capital up to several multiples of the original amount invested to leverage or enhance the returns of the underlying investment. A principal protection guaranty or wrap is then applied to provide credit enhancement and to mitigate or substantially eliminate the risk of loss of the original investment. The combination of underlying returns plus the net impact of the applied leverage will be greater than or equal to the net present value of the future unfunded liability or debt service gap, producing stronger credit fundamentals and a rating upgrade or improvement. Adhering to each specific step of this business method process produces the tangible result of eliminating an unfunded liability.

A debt redemption fund according to the present invention assists governments to repay external obligations and provides an additional source of principal-risk free external revenue generation that is dedicated to external debt repayment.

The fund of the present invention is a superior Debt Sinking Fund that provides substantive contributions at maturity of external obligations with no investment principal risk. The fund's assets are protected at maturity of external obligation by a The guarantor bank.

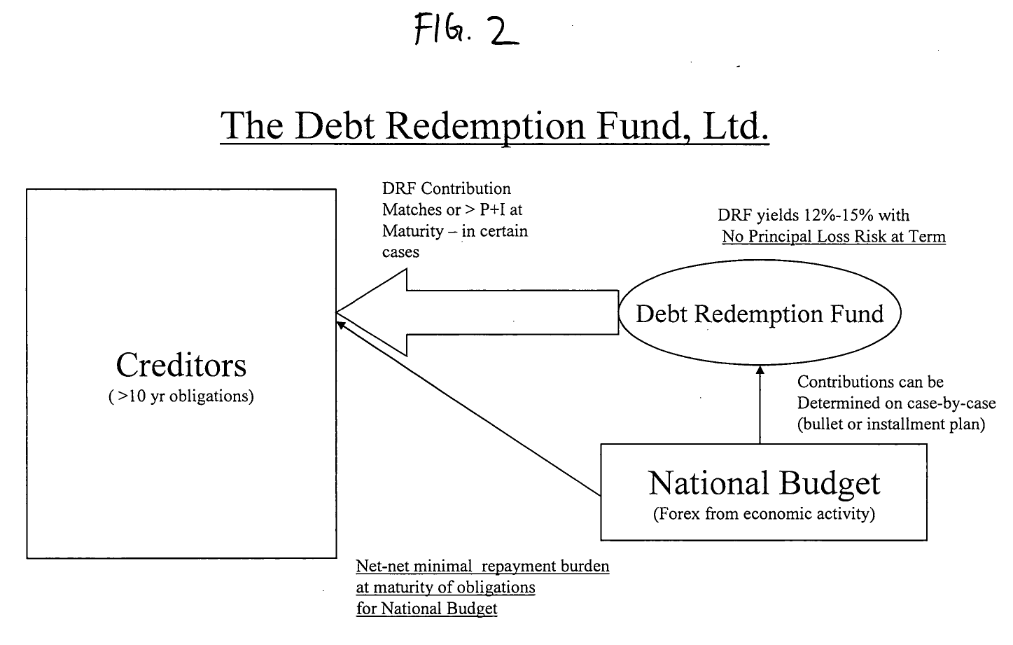

A debt redemption fund (the DRF) of the present invention is illustrated in FIG. 2. Contributions the DRF can be pre-determined on case-by-case (bullet or installment plan). the DRF yields 12%-15% with no principal loss risk at term. the DRF's contribution to matches or exceeds principal plus interest at maturity.

Neither the DRF, nor The guarantor bank, proposes to legally substitute itself for government in the repayment of government's external obligations. Short of that, the DRF substantially contributes to repayment of obligations with no risk to principal invested. the DRF proposes to provide an additional source of revenue to governments.

the DRF offers an effective asset/liabilities management tool (e.g.: debt management; provisioning; fiscal discipline, etc.) with significant macroeconomic implications (credit rating, etc).

For example, in one embodiment of the invention, the Debt Redemption Fund (the DRF) is an Asset Liability Management (ALM) tool targeted at Sovereign and Institutional Investors interested in hedging long-term outstanding foreign exchange obligations.

the DRF structures a process by which the client can access liquidity on preferential terms, provision for future obligations while meeting current domestic or existing short term obligation, and garner a credit rating that would facilitate future direct capital markets access on an unfettered basis.

the DRF process begins with a detailed examination of the structure and nature of outstanding obligations (maturity, coupons, terms, and currency) in order to ascertain the character of cash flows that need to be hedged. It is understood that, in this embodiment, the client is one that has limited reserves, difficult access to international capital markets to raise required liquidity to meet its obligations and may or may not have a credit rating.

Following this examination of the Debt Portfolio, specific obligations are identified as target for repayment by the DRF. These obligations are then used to determine the amount of set-aside the client has to invest in the DRF in order to generate the required income to pay off these obligations at term. Also determined is the implicit rate of return the DRF should generate in order to payoff targeted obligations at term.

Next, an amount of capital allocation is determined to augment client's set aside amounts. the DRF raises these amounts on an off-balance sheet and non-recourse basis with respect to the client. Both client set-aside and raised monies are invested in aggregate. The returns generated accrue in totality to the client's benefit.

the DRF's target return is determined by tactical asset allocation mechanism that determines the optimal allocation of capital to a wide array of asset classes and strategies.

In order to preserve client set-aside principal, the DRF purchases principal insurance from a bank. This principal insurance guarantees that losses are mitigated in favor of the client. The principal insurance mechanism also facilitates access to capital on a non-recourse basis within investment parameters determined by the principal insurance provider or bank.

All investments are monitored on a monthly basis and investment strategies are adjusted accordingly. Another lever to make adjustments in performance is augmenting capital as appropriate.

Principal insurance can be made to dynamically apply to principal and returns on an annual basis or more frequent basis depending on negotiated terms with insurer. This feature enables guaranteed returns on a retroactive basis.

Following this process, the DRF then engages in putting in place Asset Liability Management framework. This involves an assessment of appropriate Liability benchmarks which client can use to determine optimal debt portfolios to hold. Also, Asset benchmarks are determined to identify optimal asset portfolios to hold.

the DRF then, in consultation with client, determines a debt issuance plan and strategy that meets national funding requirements. the DRF then establishes an issuance facility with a number of banks to facilitate access to capital markets. Each issuance has a set-aside predetermined with is invested in the DRF as a hedge against future inability to meet payments on obligations.

The combination of these steps improve the client profile in the markets and with rating agencies and this in turn improve independent access and positive track with international capital markets.

This furthermore, enables client to circumvent funding solutions that require onerous economic and social adjustments in order to meet their outstanding obligations.

From the investors' perspective, they purchase a AA-rated The guarantor bank 10 yr Bond whose coupon is linked to the performance of the DRF, whose target performance is 12%-15% per annum, net to investors. At maturity, The guarantor bank commits to returning, in the worst case, 100% of the principal invested in the DRF.

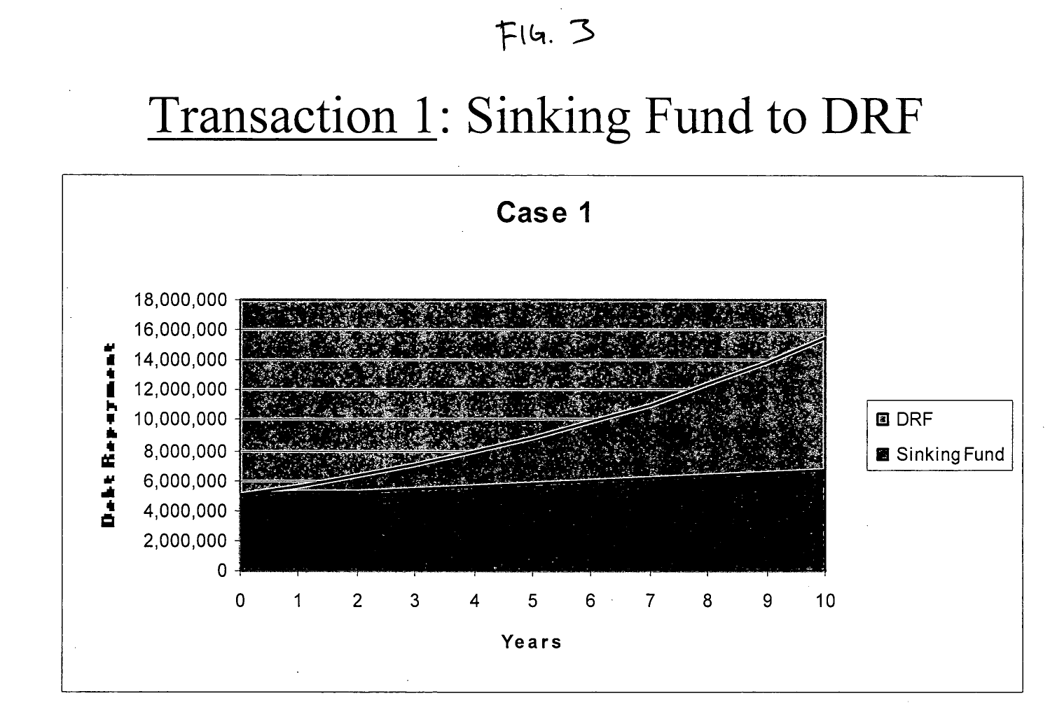

A sample transaction according to this embodiment of the present invention is illustrated in FIG. 3. In FIG. 3, a Sinking Fund managed by central bank is returning a LIBOR (London interbank offered rate) of 4.5% avg. per annum with no principal protection. the DRF management in conjunction with the central bank review the external debt portfolio for targeted obligations the DRF can significantly contribute to repaying (structure of debt, terms of repayment, current set aside, etc.) The set aside identified for investment into the DRF is $5 million to pay off $15 million in 2013 (which is derived from (1.12)ˆ10=3.11*US$5 mil=US$15.5 mil in 2013.).

Given this, the guarantor bank issues a AA rated Bond to central bank. The Bond's coupons are linked to the DRF's performance. Come maturity, central bank receives its original investment ($5 million) plus the DRF's performance $10+ million for a total of $15.5 million.

In the alternative, conventional art related scenario, LIBOR over 10 years provides only $1.7 million with no principal protection.

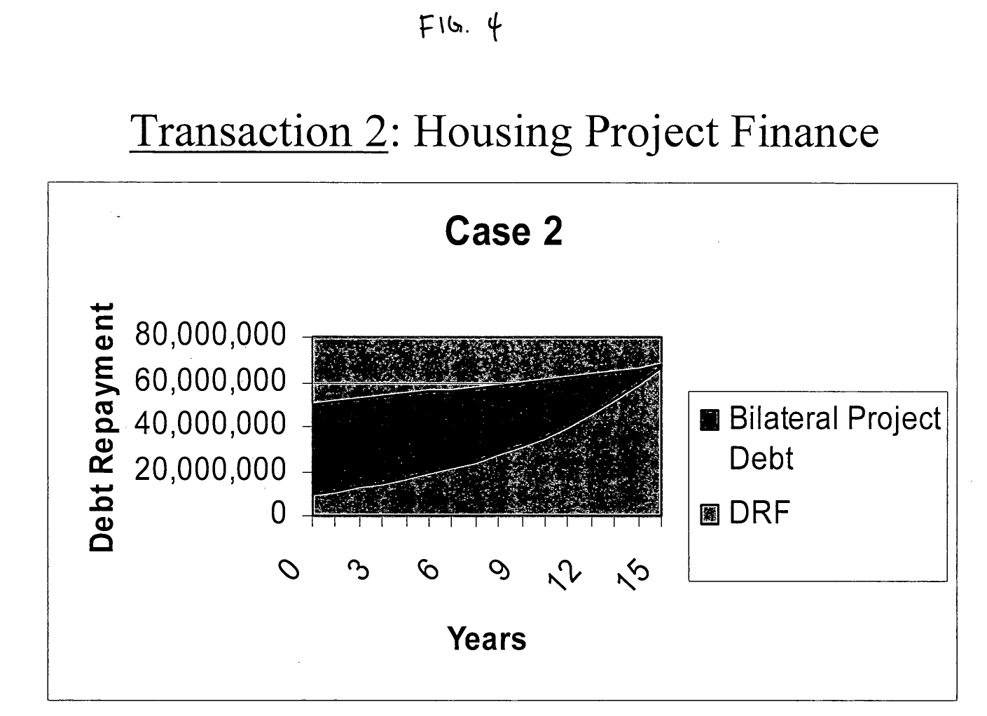

A second example is illustrated in FIG. 4. Here, a government housing project financing for a government with non-US$ revenues has a pending bilateral loan agreement for US$50 million to fund low-income housing. The Loan terms are: (a) evidencing of US$10 mil today; (b) interest of 1.5% for 15 years (bullet). The government's concerns are: (a) currency exposure; and (b ) repayment guarantee.

In the transaction according to this exemplary embodiment of the present invention, government puts US$10 million it has into the DRF, and in exchange receives transferable The guarantor bank AA rated the DRF-linked Bond. The government gives the guarantor bank the DRF-linked bond to. bilateral counterpart as evidence and proxy for repayment. At maturity, bilateral counterpart receives US$63 million from guarantor.

The government has thus financed a US$50 million project with USD$10 million with no net National Budget outflow or net currency exposure. It receives back a “surplus” of US$18 million. More importantly, housing has been made more affordable as a result.

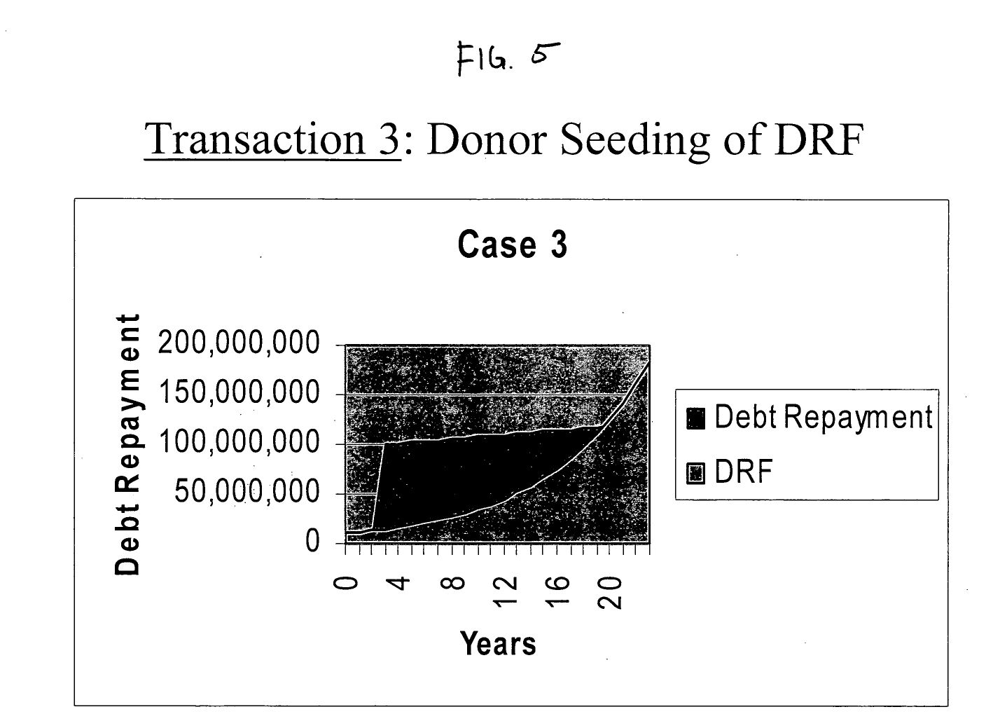

A third exemplary embodiment, illustrated in FIG. 5, relates to a Donor funded Debt Repayment. In this example, the country has no available set-asides (HIPC) to contribute to the DRF for external debt repayment. In this embodiment, third party contributions are made on behalf of HIPC countries by donors, IDA, etc.

In this transaction, as with Sinking Funds, the guarantor bank the DRF-linked AA Bond is issued to HIPC in exchange for the seeding of the DRF (key obligations would be targeted).

At maturity, the guarantor would pay to government both the original seeding as well as the DRF returns generated over the period. Due to common “repayment grace periods” excess returns or surpluses are likely to be generated.

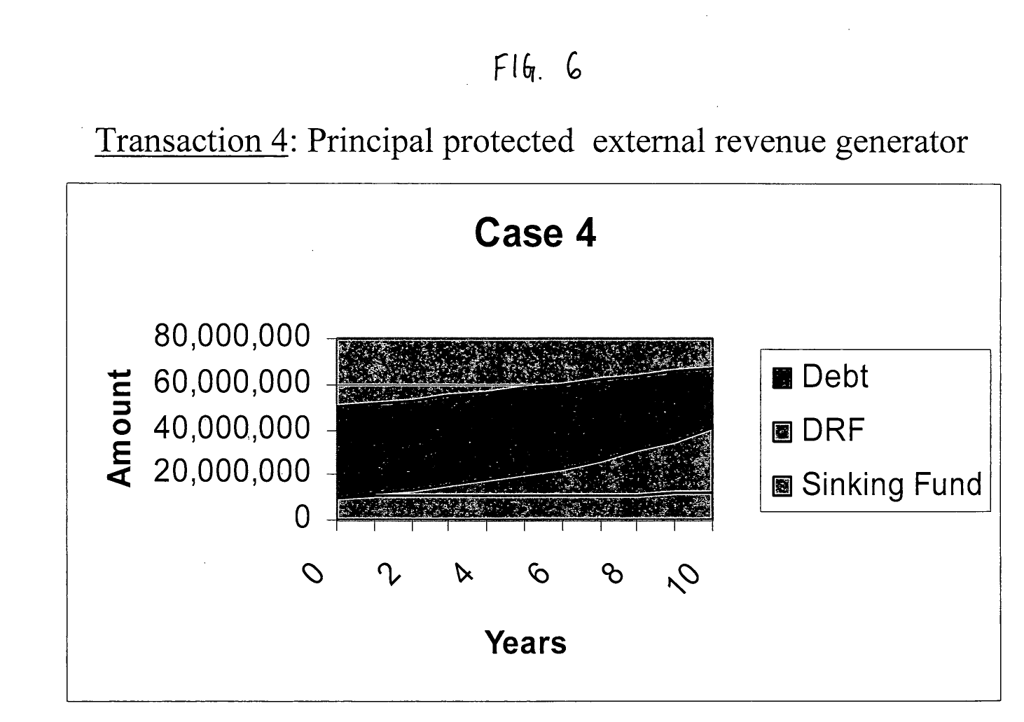

A fourth exemplary embodiment, illustrated in FIG. 6, describes an alternative use of the DRF.

Here, the government/central bank simply wants absolute returns with principal protection. In this case, no screening of obligations would take place. The level of central bank contribution would be determined as well as expected returns. The guarantor would issue the DRF-linked bond to central bank.

At maturity, the guarantor would pay to central bank the original investment as well as the DRF returns generated over the period.

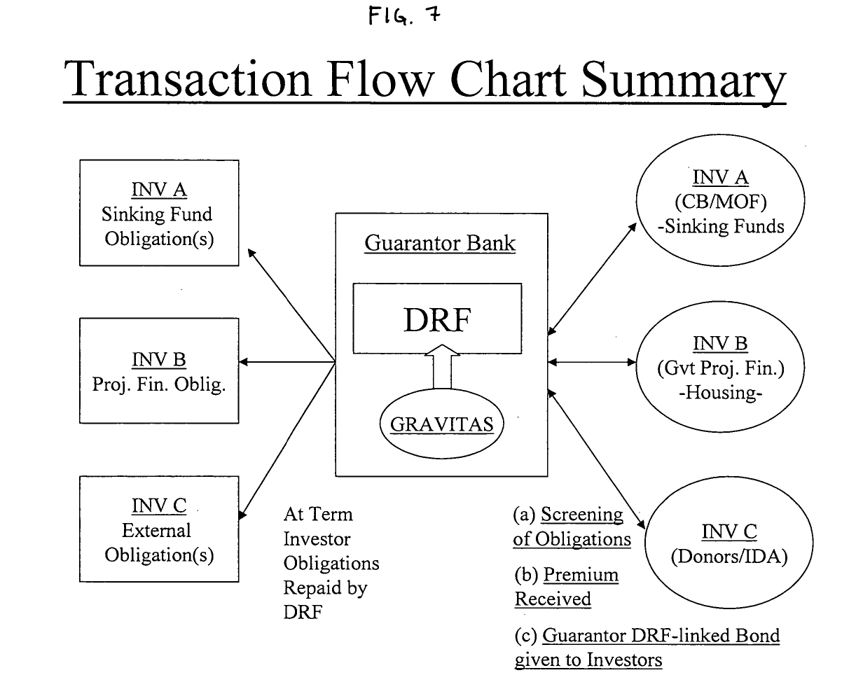

FIG. 7 summarizes the exemplary transactions discussed herein with relation to the DRF.

There are five parties involved in the DRF structure, the guarantor of principal, the debt redemption fund, ltd., the investment advisor, the custodian/fund administrator, and the external auditors.

The guarantor of principal is a bank rated at least AA that issues a guarantee to each investor, in the form of a bond against its own balance sheet, for the entire principal amount invested in the DRF. The guarantor bank may be selected through bidding among highly rated banks in the global marketplace. In return for providing a guarantee on principal invested the bank receives a fee that is locked-in for the life of the DRF (10 yrs). In addition, the bank establishes the DRF investment parameters as well as provides yield enhancement (up to 2× of invested principal—return multiplier/credit facility) based on periodic positive returns generated by the DRF.

The debt redemption fund is structured as a fund of collective investment vehicles combining a wide array of investment strategies to generate above average core returns. The focus is on capturing performance. The form in which it is provided varies (LP, MF, SA . . . ) but it is always transparent, understandable, and consistent to qualify.

These returns are in turn enhanced through the guarantor's balance sheet allocations (credit facility). Strategies utilized range from fixed income (government, corporate and municipal debt) to equity (corporate, emerging market, commodities, and currency). A total of 30-40 funds are utilized at any given time to take advantage of risk diversification as well as absolute return generation.

The DRF is managed by an Investment Advisor within parameters suggested by the guarantor bank.

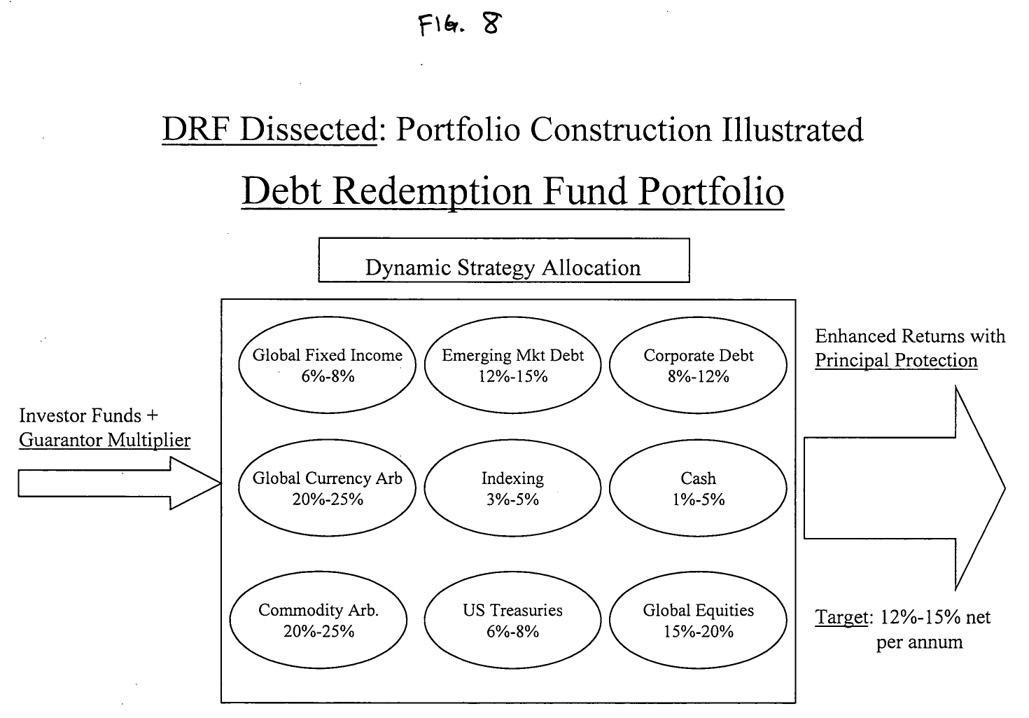

FIG. 8 illustrates a possible and exemplary portfolio allocation for the debt redemption fund of the present invention.

To protect its obligation to Sovereigns, the bank provides the DRF with guidelines, Performance Risk Control Mechanisms, against which institutional funds are to be managed. These include portfolio volatility limits, opportunity cost parameters (vs. US treasuries), detailed portfolio diversification parameters (strategy buckets), weekly returns analysis, monthly risk reports, and quarterly strategy conference calls. The DRF positive monthly performance is rewarded with bank multiplier credits (increased balance sheet allocations) which in turn further enhance performance.

The DRF may further include a profit lock-in feature (monthly, quarterly or annually). The bank may also reduce credit facility and purchase US Treasuries as the DRF's performance retreats—protecting principal & locked-in profits.

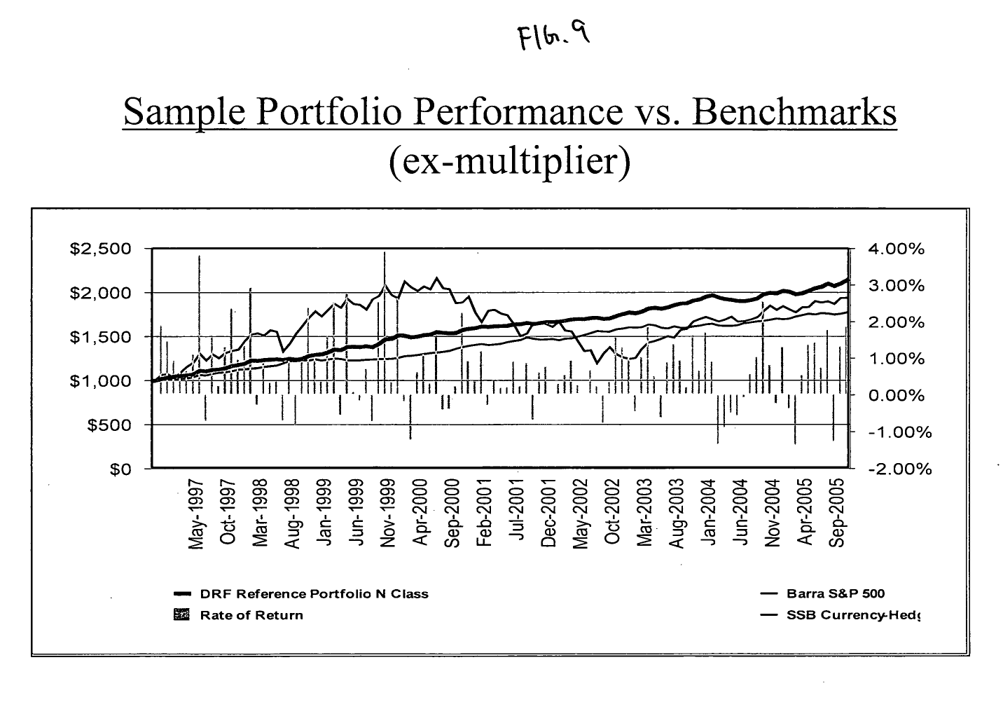

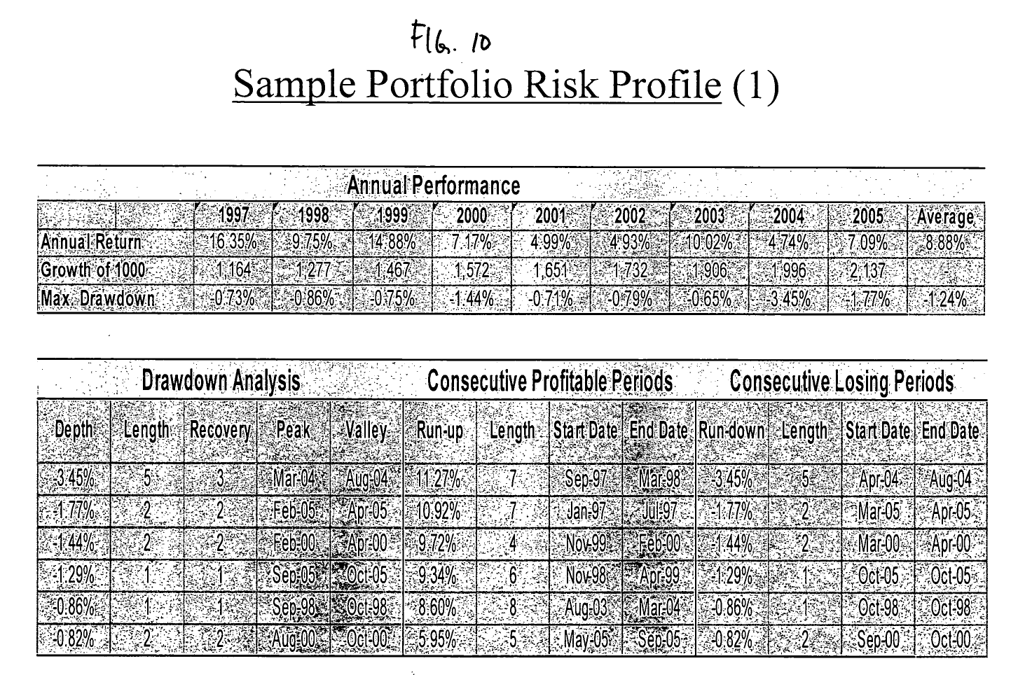

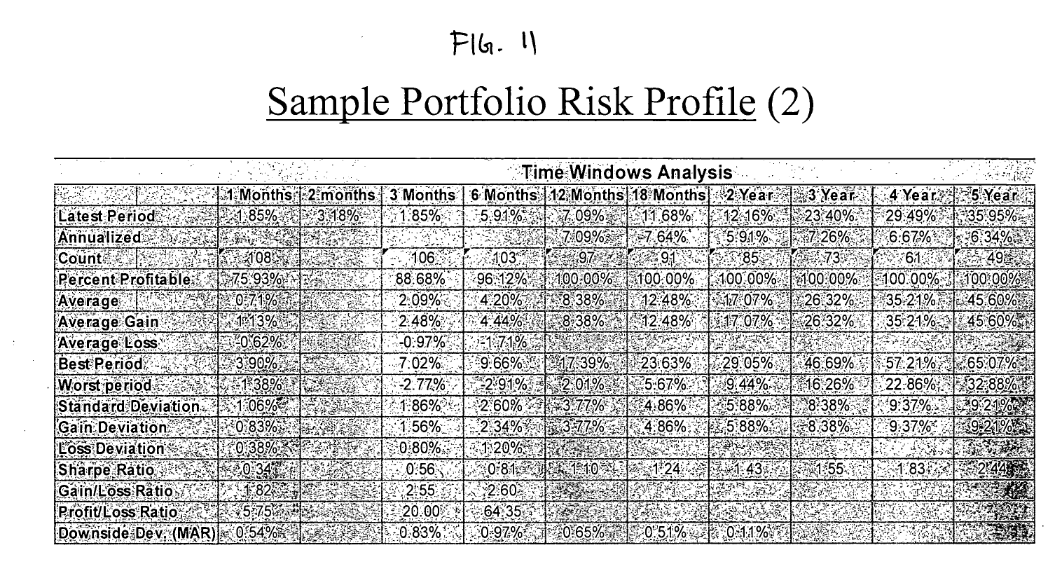

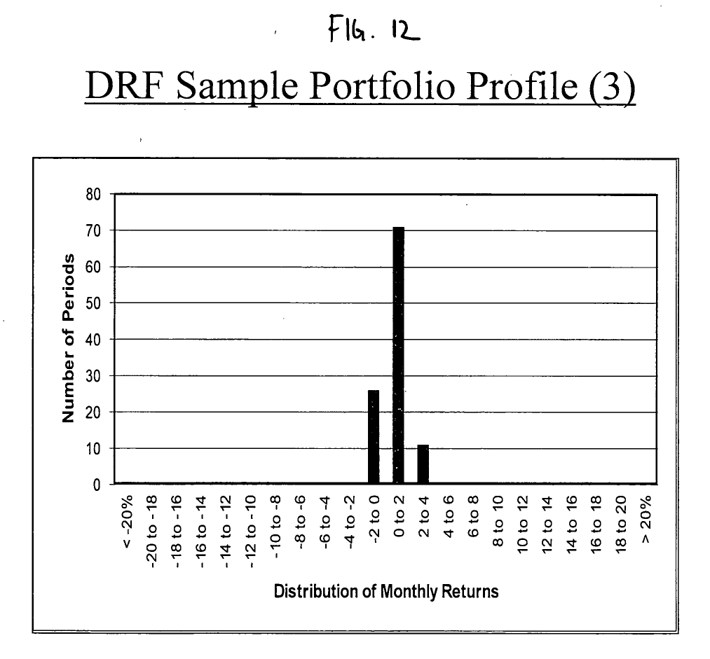

FIG. 9 illustrates sample portfolio performance versus performance benchmarks. FIGS. 10-12 illustrate sample portfolio risk profiles and profiles.

The Investment Advisor has the responsibility of defining investment strategy on a quarterly and annual basis. This is submitted to the guarantor bank for approval against suggested parameters. Once approved, funds are invested according to planned strategy and monitored against volatility parameters on a monthly basis. The Investment Advisor may or may not be a registered Investment Advisor.

The Investment Advisor reports on a quarterly basis based on information provided by the Fund Administrator and Custodian, and may reserve the right to appoint consultants and sub-advisors that will assist with the dispensation of its advisory tasks.

The DRF has a legally separate Fund Administrator/Custodian.

The Custodian/Administrator provides all back-office and middle office support to the Investment Advisor, and reports to Investment Advisor, The guarantor bank and Regulators. It administers funds received by the guarantor bank from institutional investors and assists with the proper allocation to underlying funds within the DRF's designated portfolio. It generates all reports related to performance, risk allocations and other oversight documents, including net asset valuations on a daily, monthly, quarterly and annual basis.

The DRF uses external auditors to validate its performance on an annual basis. External auditors are charged with auditing returns on behalf of the guarantor bank, the DRF's Board of Directors, Regulators and Institutional Investors. These audits are reported on an annual basis and available to institutional investors upon request.

Investor's Legal Recourse is described as follows. As the issuer of the DRF-linked Bond, the guarantor bank is the first recourse of investors. The DRF documentation identifies the guarantor bank as the obligator (bond issuer) and governments as bond investor.

Furthermore, the DRF may be subject to regulatory oversight. The investment advisor may be regulated by SEC or other securities agency, and the guarantor bank is regulated by both IMRO and SEC.

The DRF may be provided with additional features in various aspects of embodiments of the invention. For example, the DRF may have a profit lock-in. in which returns are locked-in via volatility limits, thereby providing downside protection. The DRF provides for liquidity, namely the availability for future contributions & withdrawals. Other features may include credit facility (return enhancement source) and curve freezing (eliminating Treasury opportunity cost (Tranche)),

Investors can participate in strategy conference calls with the DRF Investment Advisor, and monthly NAVs and quarterly performance reports can be generated for each investor.

Depending on the features selected, the DRF fees can range from 0.50%-1.5% per annum, but may be set above or below those ranges as circumstances allow.

Thus, the DRF lightens the burden on national budgets (external debt, project finance), provides a “principal protected” external revenue generator (target: 12%-15% per annum), and is an effective government liability management tool.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for reducing the unfunded liability of an institution, comprising:
identifying a range of investment vehicles;
calculating a plurality of specific risk profiles for said investment vehicles;
developing a composite volatility measure to allow the application of additional capital up to several multiples of the original amount invested to leverage or enhance the returns of the underlying investment; and
wrapping a principal protection guaranty to mitigate risk of loss of the original investment.
